(19) United States
(12) Patent Application Publication
(10) Pub. No.: US 2008/0043460 A1
(43) Pub. Date: Feb. 21, 2008

(54) Electroluminesent pavement markers

(76) Inventor: John W. Arnett, Washington, DC (US)

Correspondence Address: Michael S. Gzybowski;Butzel Long, P.C., Suite 300, 350 S. Main St., Ann Arbor, MI, 48104, US

(21) Appl. No.: 11/506,465

(22) Filed: Aug. 18, 2006

(51) Int. Cl. E01F 9/00; H05B 33/00

(52) U.S. Cl. 362/153.1; 362/84

(57) ABSTRACT

Electroluminescent lights or devices that are used as visual pavement markers on highways, streets, roads, parking lots, etc. The electroluminescent lights or devices can be illuminated regularly to provide visible recognition of the edges of a highway, street, road, etc. or lane or parking space markers, turn lane indicators or the like. Alternatively, the electroluminescent lights or devices can be used as a backup system to provide illuminated, visual markings along dark pavement areas which primary systems such as street lights fail. The electroluminescent lights or devices can be in the form of thin flexible strips that can be incorporated into or on the surface of various pavement materials.

### RELATED APPLICATION

The present application is based upon Provisional Patent Application Ser. No. 60/______, filed Aug. 18, 2005 and entitled ELECTROLUMINESCENT STREET LINES REPLACEMENT, to which priority is claimed under 35 U.S.C. §120 and of which the entire disclosure is hereby expressly incorporated by reference.

### TECHNICAL FIELD

The present invention relates to visible lines which are used for pavement markings. More particularly, the present invention is directed to the use of electroluminescent strips that are used as pavement markings to mark the edges of a highway, street, road, etc. or lane or parking space markers, turn lane indicators or the like.

### BACKGROUND ART

Currently various types or paints, coatings, laminates, etc. are used to mark the edges and/or centers of highways, streets, roads, etc. or to mark individual lanes, or as parking space markers, turn lane indicators or the like. Such coatings paints, coatings, laminates, etc. are generally formulated to be highly visible and/or have a reflective nature or property.

In addition, various reflector devices are known to be attached to or embedded into highways, streets, roads, etc. to provide similar visual marking or indications.

One problem with such current types of similar visual markers or indicators is that they generally are designed to be visible by reflecting light. In the absence of light that can be reflected, they might not be visible at all or not sufficiently visible to be seen.

The present invention provides illuminated marking strips that can be used as pavement markings to mark the edges of a highway, street, road, etc. or lane or parking space markers, turn lane indicators or the like.

### DISCLOSURE OF THE INVENTION

According to various features, characteristics and embodiments of the present invention which will become apparent as the description thereof proceeds, the present invention provides a pavement provide with a visible marking system, wherein the marking system comprising an electroluminescent device.

The present invention further provides a marking system for a pavement which comprises at least one electroluminescent device that is incorporated into a pavement.

### BEST MODE FOR CARRYING OUT THE INVENTION

The present invention is directed to illuminated marking strips that can be used as pavement markings to mark the edges of a highway, street, road, etc. or lane or parking space markers, turn lane indicators or the like. More particularly, the present invention is directed to the use of electroluminescent strips that are used as pavement markings to mark the edges of a highway, street, road, etc. or lane or parking space markers, turn lane indicators, traffic flow direction indicators, or the like.

Electroluminescent lights have been developed for numerous indoor and outdoor uses. In particular, electroluminescent lights or devices can be in the form of flat panels that can be fabricated plastic materials.

The present invention involves incorporating electroluminescent lights or devices into various pavements, wherein the term “pavements” as used herein includes highways, streets, roads, parking lots, etc. which can be made from concrete, asphalt, gravel, etc.

According to the present invention the electroluminescent lights or devices are used in place of, or as a substitute for conventional pavement markers in that, for example, they can be provided along the edge of a pavement so as to illuminate and provide for visual identification of the edge of the pavement at night.

Alternatively, the electroluminescent lights or devices can be used in place of all types of conventional pavement markers such as lane or parking space markers, turn lane indicators, traffic flow direction indicators, or the like. Alternatively, the electroluminescent lights or devices can be used together with any type of conventional pavement marker so as to provide either additional night time visibility or as a back-up illuminated visual marking means in the event that other primary illumination sources fail, such as vehicle or street lights.

The electroluminescent lights or devices can be on the surface of a pavement or embedded into a pavement so as to be substantially flush with the surface of the pavement. For Example, when the electroluminescent lights or devices are used to mark the edges of a pavement, they can be provided on the surface of the pavement, along the edges where vehicle traffic is not usually encountered. On the other hard, when the electroluminescent lights or devices are used as lane markers they can be embedded in the pavement surface for protection and to avoid interfering with traffic movement.

Because the electroluminescent lights or devices can be in the form of very thin, e.g. 0.01 inch think strips which are very flexible and light weight, they an easily be attached to (e.g. by any suitable adhesive material or mechanical means) to embedded or incorporated into any type of pavement.

The electroluminescent lights or devices can be provided as long thin strips or as a series of discrete short strips that are spaced apart. According to the present invention electroluminescent strips that are up to 500 feet in length and are draw from 25-45 w of electrical power are believed to be particularly useful as pavement edge markers. Although electroluminescent lights or devices can be in the form of strips, the shape of the electroluminescent lights or devices are not limited to strip shapes, but could be in the form of turn arrows, direction arrows, or any desired shape.

In order to power the electroluminescent lights or devices suitable ballasts or ballasts systems can be providing in subsurface instillations such as water-proof enclosures or even small vents or above surface instillations. The necessary electrical power can be fed to the electroluminescent lights or devices from any convenient source. Alternatively, the electroluminescent lights or devices can be illuminated by rechargeable batteries which can in turn be provided with solar recharging systems.

The electroluminescent lights or devices can be used regularly to provide illuminated, visual markings along dark pavement areas.

Alternatively, the electroluminescent lights or devices can be installed and used as a backup system to provide illuminated, visual markings along dark pavement areas which primary systems such as street lights fail.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and in the claims which follow.

What is claimed is:

1. In a pavement provide with a visible marking system, the improvement which comprises said marking system comprising an electroluminescent device.

2. A pavement according to claim 1, wherein the pavement comprises one of a highway, road, street, or parking lot.

3. A pavement according to claim 1, wherein the electroluminescent device comprises a thin strip.

4. A pavement according to claim 1, wherein the electroluminescent device is provided along an edge of the pavement.

5. A pavement according to claim 1, wherein the electroluminescent device is provided along a central portion of the pavement.

6. A pavement according to claim 1, wherein the electroluminescent device is provided on a surface of the pavement.

7. A pavement according to claim 1, wherein the electroluminescent device is embedded in a surface of the pavement.

8. A marking system for a pavement which comprises at least one electroluminescent device that is incorporated into a pavement.

9. A marking system according to claim 8, wherein the at least one electroluminescent device comprises a plurality of electroluminescent devices.

10. A marking system according to claim 8, wherein the pavement comprises one of a highway, road, street, or parking lot.

11. A marking system according to claim 8, wherein the at least one electroluminescent device comprises a thin strip.

12. A marking system according to claim 8, wherein the at least one electroluminescent device is provided along an edge of the pavement.

13. A marking system according to claim 8, wherein the at least one electroluminescent device is provided along a central portion of the pavement.

14. A marking system according to claim 8, wherein the at least one electroluminescent device is provided on a surface of the pavement.

15. A marking system according to claim 8, wherein the at least one electroluminescent device is embedded into a surface of the pavement.
